(19) United States
(12) Patent Application Publication
(10) Pub. No.: US 2009/0324509 A1
(43) Pub. Date: Dec. 31, 2009

(54) INSECTICIDAL COMPOSITION

(75) Inventor: Sujay Anil Shah, London (GB)

Correspondence Address: INTELLECTUAL PROPERTY / TECHNOLOGY LAW, PO BOX 14329, RESEARCH TRIANGLE PARK, NC, 27709, US

(73) Assignee: LIVIE BIOPESTICIDES LIMITED, London (GB)

(21) Appl. No.: 12/375,532

(22) PCT Filed: Jul. 31, 2007
(86) PCT No.: PCT/GB2007/002901

§ 371 Date: Feb. 24, 2009

(30) Foreign Application Priority Data
Aug. 3, 2006 (GB) 0615473.6

(51) Int. Cl. A01N 25/06; A01N 27/00; A01N 37/06

(52) U.S. Cl. 424/45; 514/762; 514/549

(57) ABSTRACT

A pesticidal composition which comprises cymene and either a pyrethrin insecticide or an insect growth regulator. In particular the composition is formulated as an aerosol for killing or controlling pests and in particular flying pests.

The invention relates to a composition comprising cymene and as second component which acts synergistically with it, which is selected from an insect growth regulator (IGR) or a pyrethrin insecticide and its use as a pesticidal composition against insects and arachnids and in particular against flying and crawling insects.

Pyrethrum is a highly effective pesticide which has been used for centuries against all manner of insect pests. Pyrethrum is a natural plant oil that is present in the pyrethrum daisy, Chrysanthemum (Tanacetum) cinerariae folium, a member of the chrysanthemum family. It is found mainly in tiny oil containing glands on the surface of the seed case in the tightly packed flower head and is the plant's own pesticide that keeps insects away. Pyrethrum is made up of six complex chemical esters known as pyrethrins, which work in combination to repel and kill insects. Pyrethrum is a unique pesticide in that, used correctly, it is safe for use near humans and warm blooded animals, and for example in kitchens and restaurants, food processing factories and other sensitive environments.

Many synthetic insecticides based to some extent upon the chemical structure of the pyrethrins have been developed and these are known as pyrethroids. For the avoidance of doubt, as used herein the expression “pyrethrin insecticide” or “pyrethrin insecticides” includes both pyrethrins (which may be synthetic or obtained from natural sources), and pyrethroids which are the synthetic insecticides.

One of the most important problems associated with pyrethrins is that resistance is already beginning to be found in many insect species in several parts of the world. Pyrethrin resistance caused either by specific detoxification enzymes or an altered target site mechanism (kdr-type mutations in the sodium channels), has been reported in most continents. If resistance continues to develop and spread at the current rate, it may render such pesticides ineffective in their current form in the not too distant future. Such a scenario would have potentially devastating consequences in public health terms, since they are yet no obvious alternatives to many of the uses of pyrethrins. Therefore, it is necessary to develop new and effective pesticides.

Accordingly, it would, therefore, be desirable to provide a new and effective pesticide which has high insect mortality, low mammalian toxicity, low residual activity, rapid knockdown, low cost, no existing resistance in target pest species and the low possibility of future resistance developing.

In a first aspect the present invention provides a pesticidal composition comprising cymene and either a pyrethrin insecticide or an insect growth regulator (IGR).

In a subset of the first aspect, the present invention provide a pesticidal composition comprising cymene and a pyrethrin insecticide.

In particular, in a second aspect the present invention provides a pesticidal composition comprising cymene and an insect growth regulator.

In a third aspect the present invention provides a method for the control of pests which comprises administering to the pest or its environment a pesticidally effective amount of the pesticidal compositions of the present invention.

In a fourth aspect the present invention provides a method for the control and/or eradication of pest infestations of animals and/or of plants, and/or stored products which comprises administering to the animal or locus an effective amount of the pesticidal compositions of the present invention.

In a fifth aspect the present invention provides pesticidal compositions of the present invention for use in human and veterinary medicine, in public health control and in agriculture for the control of pests.

In a sixth aspect the present invention provides a method for making the pesticidal compositions of the present invention comprising combining cymene with either a pyrethrin or an insect growth regulator.

In a seventh aspect the present provides the use of the compositions of the present invention as a pesticide.

The present inventors have found that by combining cymene with an insect growth regulator or a pyrethrin insecticide, pesticidal compositions are produced which have a broad spectrum efficacy against a very wide range of pests such as insects and arachnids and in particular flying and crawling insects, have low mammalian toxicity, rapid knockdown and mortality, low cost and no existing resistance in target species and have a low possibility of future resistance developing.

A further advantage of the composition of cymene with an insect growth regulator is that the life of the product is increased to several months. Cymene on its own, for example is volatile and evaporates in a couple of hours.

The present invention will now be further described. In the following passages different aspects of then invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Preferably, the composition comprises synthetically prepared and therefore highly pure cymene. Cymene may also be derived from a plant extract, such as an essential oil. Particularly, the extract is derived from plants comprising cymene, such as Thyme (Thymus vulgaris L; Thymus ssp), Monarda punctata L. savory (e.g. Satareja hortensis), Cumin (e.g. Cuminum cyminum) and Labiatae. A “plant extract” according to the invention is an extract from plant material. “Plant material” is defined as a plant or a part thereof (e.g. bark, wood, leaves, stems, inflorescence, roots, fruits, seeds or parts thereof). The extract may be prepared from plant material by one or more of the following processes: pulverisation, decoction or other processes known in the art. A plant extract may, but preferably does not, constitute a highly purified substance derived from natural sources and will generally also contain other plant-derived substances. Thus, in the case of cymene, a plant extract derived from one or more plants will generally include highly purified, pharmaceutical-grade cymene. However, a skilled person will appreciate that a plant extract may be further purified to obtain highly purified substances.

Suitably, in accordance with the invention, the cymene is not in the form of an essential oil, but rather is a synthetic material or an extract or isolate from an essential oil. Thus the composition will suitably be free of at least some and preferably all of the other components of an essential oil which contains cymene.

In a preferred embodiment the pesticidal composition of the present invention comprises p-cymene.

In tests, this compound has been found to have a broad spectrum insecticidal activity against a range of pests including Musca domestica, (House fly), Periplaneta Americana, (American cockroach), Blatella germanica (German cockroach), Phlebotomus papatasi (Sandfly), Stomoxys calcitrans (Stable fly), Glossina morsitans (Tsetse fly), Cimex leticularis (Bed bug), Ctenocephalides felis (Cat flea), Rhodnius prolixus (Redjuvid bug), Triatoma infestans (Cone nose bug), Culicoides variipennis (Biting midge), Ixodes ricinus (Deer tick), Simulium damnosum (Black fly), Vespula vulgaris (Common wasp) and Tenebrio molitor (Mealworm beetle)

Thus in itself, cymene clearly has a broad-spectrum efficacy against a very wide range of medically important insect species. The use in the composition of the invention means that this efficacy can be realised in a useful manner. To achieve this, the cymene can be combined with an insect growth regulator or a pyrethrin insecticide.

In a particular embodiment, the cymene is combined with a pyrethrin insecticide. The pyrethrin insecticide may be a natural or synthetic pyrethrin, as well as a pyrethroid. Examples include:
Pyrethrin I (the pyrethrolone ester of chrysanthemic acid);
Cinerin I (the cinerolone ester of chrysanthemic acid);
Pyrethrin II (the pyrethrolone ester of pyrethric acid);
Cinerin II (the cinerolone ester of pyrethric acid);
Jasmolin I (the jasmololone ester of chrysanthemic acid);
Jasmolin II (the Jasmololone ester of pyrethric acid);
Allethrin (2-allyl-4-hydroxy-3-methyl-2-cyclopenten-1-one ester of 2,2-dimethyl-3-(2-methylpropenyl)cyclopropanecarboxylic acid);
Barthrin (6-chloropiperonyl 2,2-dimethyl-3-(2-methylpropenyl)cyclopropane carboxylate;
Dimethrin (2,4-dimethylbenzyl 2,2-dimethyl-3-(2-methylpropenyl)cyclopropane carboxylate;
Tetramethrin (1-cyclohexene-1,2-dicarboximidomethyl 2,2-dimethyl-3-(2-methylpropenyl)cyclopropane carboxylate);
Resmethrin (5-benzyl-3-furylmethyl-cis, transchrysanthemate) and
Bioresmethrin (5-benzyl-3-furylmethyl-transchrysanthemate).

Further examples of specifically pyrethroids include:
Cypermethrin ((S,R)-alpha-cyano-3-phenoxybenzyl-2,2-dimethyl (1R,1S,cis,trans)-3-(2,2-dichlorovinyl)cyclopropane-carboxylate);
Cyphenothrin (RS)-α-cyano-3-phenoxybenzyl (1RS,3RS;1RS,3SR)-2,2-dimethyl-3-(2-methylprop-1-enyl)cyclopropanecarboxylate);
Empenthrin ((E)-(RS)-1-ethynyl-2-methylpent-2-enyl (1RS,3RS;1RS,3SR)-2,2-dimethyl-3-(2-methylprop-1-enyl)cyclopropanecarboxylate);
Tralomethrin ((S)-α-cyano-3-phenoxybenzyl (1R,3S)-2,2-dimethyl-3-[(RS)-1,2,2,2-tetrabromoethyl]cyclopropanecarboxylate);
Fenvalerate ((RS)-α-cyano-3-phenoxybenzyl (RS)-2-(4-chlorophenyl)-3-methylbutyrate;
Esfenvalerate ((S)-α-cyano-3-phenoxybenzyl (S)-2-(4-chlorophenyl)-3-methylbutyrate);
Permethrin (including trans-permethrin);
Bioallethrin-((RS)-3-allyl-2-methyl-4-oxocyclopent-2-enyl (1R,3R)-2,2-dimethyl-3-(2-methylprop-1-enyl)cyclopropanecarboxylate) such as S-bioallethrin;
Dimethfluthrin (2,3,5,6-tetrafluoro-4-(methoxymethyl)benzyl (1RS,3RS;1RS,3SR)-2,2-dimethyl-3-(2-methylprop-1-enyl)cyclopropanecarboxylate);
Flucythrinate ((RS)-α-cyano-3-phenoxybenzyl (S)-2-(4-difluoromethoxyphenyl)-3-methylbutyrate);
Fluvalinate ((RS)-α-cyano-3-phenoxybenzyl N-(2-chloro-α,α,α-trifluoro-p-tolyl)-DL-valinate);
Furethrin ((RS)-3-furfuryl-2-methyl-4-oxocyclopent-2-enyl (1RS,3RS;1RS,3SR)-2,2-dimethyl-3-(2-methylprop-1-enyl)cyclopropanecarboxylate);
Imiprothrin (mixture of 20% 2,5-dioxo-3-prop-2-ynylimidazolidin-1-ylmethyl (1R,3S)-2,2-dimethyl-3-(2-methylprop-1-enyl)cyclopropanecarboxylate and 80% 2,5-dioxo-3-prop-2-ynylimidazolidin-1-ylmethyl (1R,3R)-2,2-dimethyl-3-(2-methylprop-1-enyl)cyclopropanecarboxylate);
Metofluthrin (2,3,5,6-tetrafluoro-4-(methoxymethyl)benzyl (EZ)-(1RS,3RS;1RS,3SR)-2,2-dimethyl-3-prop-1-enylcyclopropanecarboxylate);
Kadethrin (5-benzyl-3-furylmethyl (E)-(1R,3S)-2,2-dimethyl-3-(2-oxothiolane-3-indenemethyl)-cyclopropanecarboxylate);
Tetramethrin (cyclohexene-1,2-dicarboximidomethyl (IRS)-cis,trans-2,2-dimethyl-3-(2-methylpropenyl)cyclo-propanecarboxylate);
Phenothrin (3-phenoxybenzyl (1RS,3RS;1RS,3SR)-2,2-dimethyl-3-(2-methylprop-1-enyl)cyclopropanecarboxylate);
Prallethrin ((RS)-2-methyl-4-oxo-3-prop-2-ynylcyclopent-2-enyl (1RS,3RS;1RS,3SR)-2,2-dimethyl-3-(2-methylprop-1-enyl)cyclopropanecarboxylate);
Profluthrin (2,3,5,6-tetrafluoro-4-methylbenzyl (EZ)-(1RS,3RS;1RS,3SR)-2,2-dimethyl-3-prop-1-enylcyclopropanecarboxylate);
Pyresmethrin (5-benzyl-3-furylmethyl (E)-(1R,3R)-3-(2-methoxycarbonylprop-1-enyl)-2,2-dimethylcyclopropanecarboxylate);
Cismethrin (5-benzyl-3-furylmethyl (1R,3S)-2,2-dimethyl-3-(2-methylprop-1-enyl)cyclopropanecarboxylate);
Tefluthrin (2,3,5,6-tetrafluoro-4-methylbenzyl (1RS,3RS)-3-[(Z)-2-chloro-3,3,3-trifluoroprop-1-enyl]-2,2-dimethylcyclopropanecarboxylate);
Proparthrin/Kikuthrin (2-methyl-5-(2-propynyl)-3-furylmethyl (IRS) cis and trans-2,2-dimethyl-3-(2-methylprop-1-enyl) cyclopropanecarboxylate;
Biphenthrin ((2-methyl-3-phenyl-phenyl)methyl 3-(2-chloro-3,3,3-trifluoro-prop-1-enyl)-2,2-dimethyl-cyclopropane-1-carboxylate;
Biopermethrin (3-phenoxybenzyl (1R,3S)-3-(2,2-dichlorovinyl)-2,2-dimethylcyclopropanecarboxylate);
Bifenthrin (2-methylbiphenyl-3-ylmethyl (IRS, 3RS)-3-[(Z)-2-chloro-3,3,3-trifluoroprop-1-enyl]-2,2-dimethylcyclopropanecarboxylate);
Cyfluthrin ((RS)-α-cyano-4-fluoro-3-phenoxybenzyl (1RS,3RS;1RS,3SR)-3-(2,2-dichlorovinyl)-2,2-dimethylcyclopropanecarboxylate);
Terallethrin ((RS)-3-allyl-2-methyl-4-oxocyclopent-2-enyl 2,2,3,3-tetramethylcyclopropanecarboxylate);
Bromethrin ((5-benzyl-3-furyl)methyl-2(2,2-dibromovinyl)-3,3-dimethylcyclopropanecarboxylate);
Ethanomethrin;
Bioethanomethrin (5-benzyl-3-furylmethyl (1R,3R)-3-cyclopentylidenemethyl-2,2-dimethylcyclopropanecarboxylate);
Transfluthrin (2,3,5,6-tetrafluorobenzyl (1R,3S)-3-(2,2-dichlorovinyl)-2,2-dimethylcyclopropanecarboxylate);
Tralocythrin (RS)-α-cyano-3-phenoxybenzyl (1RS and 3RS)-3-(1,2-dibromo-2,2-dichloroethyl)-2,2-dimethylcyclopropanecarboxylate);
Fenpropanate (Cyclopropanecarboxylic acid, 2,2,3,3-tetramethyl-cyano(3-phenoxyphenyl)methyl ester);
Cypothrin (cyano-(3-phenoxyphenyl)-methyl 3,3-spiro-[cyclopropane-1,1-(1H)-indene]-2-carboxylate);
Fenfluthrin (NAK 1654) (2,3,4,5,6-pentafluorobenzyl (1R,3S)-3-(2,2-dichlorovinyl)-2,2-dimethylcyclopropanecarboxylate);
NAK 1901 (Pentafluorbenzyl (1R,cis)-3-(2,2-dichlorovinyl)-2,2-dimethyl-cyclopropane-carboxylate;
Fenpirithrin (RS)-cyano(6-phenoxy-2-pyridyl)methyl (1RS,3RS;1RS,3SR)-3-(2,2-dichlorovinyl)-2,2-dimethylcyclopropanecarboxylate);
Fenpropathrin ((RS)-α-cyano-3-phenoxybenzyl 2,2,3,3-tetramethylcyclopropanecarboxylate);
Prothrin;
Furamethrin;
Proparthrin;
Permethrin (3-phenoxybenzyl (1RS,3RS;1RS,3SR)-3-(2,2-dichlorovinyl)-2,2-dimethylcyclopropanecarboxylate);
Sumithrin (3-phenoxyphenyl)methyl 2,2-dimethyl-3-(2-methylprop-1-enyl)cyclopropane-1-carboxylate);
Acrinothrin ((S)-α-cyano-3-phenoxybenzyl (Z)-(1R,3S)-2,2-dimethyl-3-[2-(2,2,2-trifluoro-1-trifluoromethyl-ethoxycarbonyl)vinyl]cyclopropanecarboxylate);
Cyhalothrin ((RS)-α-cyano-3-phenoxybenzyl (1RS,3RS)-3-[(Z)-2-chloro-3,3,3-trifluoropropenyl]-2,2-dimethylcyclopropanecarboxylate including λ-cyhalothrin and gamma-cyhalothrin and lamba-cyhalothrin;
Cyclethrin ((RS)-3-[(RS)-cyclopent-2-en-1-yl]-2-methyl-4-oxocyclopent-2-en-1-yl (1RS,3RS;1RS,3SR)-2,2-dimethyl-3-(2-methylprop-1-enyl)cyclopropanecarboxylate;
Cycloprothrin (RS)-α-cyano-3-phenoxybenzyl (RS)-2,2-dichloro-1-(4-ethoxyphenyl)cyclopropanecarboxylate);
Deltamethrin ((S)-α-cyano-3-phenoxybenzyl (1R,3R)-3-(2,2-dibromovinyl)-2,2-dimethylcyclopropanecarboxylate;
Etofenprox (2-(4-ethoxyphenyl)-2-methylpropyl 3-phenoxybenzyl ether);
Flufenprox (3-(4-chlorophenoxy)benzyl (RS)-2-(4-ethoxyphenyl)-3,3,3-trifluoropropyl ether);
Halfenprox (2-(4-bromodifluoromethoxyphenyl)-2-methylpropyl 3-phenoxybenzyl ether);
Protrifenbute ((RS)-5-[4-(4-chlorophenyl)-4-cyclopropylbutyl]-2-fluorophenyl phenyl ether); and
Silafluofen ((4-ethoxyphenyl)[3-(4-fluoro-3-phenoxyphenyl)propyl](dimethyl)silane).

A mixture of pyrethrins can also be present. Preferably the pyrethrin is a natural pyrethrin or a mixture of natural and synthetic pyrethrins. Even more preferably the pyrethrin is pyrethrin I or pyrethrin II and mixtures thereof. However, for some applications, it will be preferable to utilize a synthetic pyrethroid insecticide such as those listed above.

Such compositions are particularly suitable for use in aerosol formulations, which will be discussed in more detail below.

In this instance, the pyrethrin insecticide used is suitably one which is known to produce a good “knock-down” activity. Examples of such pyrethrin insecticides include permethrin, cyhalothrin, deltamethrin, bioallerthrin, cypermethrin, phenothrin and tetramethrin. A particular group of pyrethrin insecticides which are known as knock-down agents include allethrin, bioallethrin, S-bioallethrin, bioresmethrin, kadethrin, resmethrin and tetramethrin. Additionally, cypermethrin, deltamethrin, fenvalerate and permethrin are known to have better knockdown than kill effects on some species, but with others, the converse is true.

The particular combination of p-cymene and a pyrethrin insecticide has been found to be particularly useful in that the properties of the individual components are complementary in that the strengths and weaknesses of each are effectively mirrored and the combination not only produces a combination of the good effects of each, but also a synergistic improvement in the overall properties, in particular as a broad spectrum pesticide.

This is perhaps best illustrated in the following Table A

TABLE A

| Characteristic | p-cymene | pyrethrum | combination |
|---|---|---|---|
| High insect | −+ | ++ | ++ |
| mortality | | | |
| Low mammalian | ++ | ++ | ++ |
| toxicity | | | |
| Low residual | −+ | ++ | ++ |
| activity | | | |
| Rapid knockdown | −− | ++ | ++ |
| No existing | ++ | −− | ++ |
| resistance in | | | |
| target pests | | | |
| Low possibility of | −+ | −− | ++ |
| future resistance | | | |
| developing | | | |
| Low cost | ++ | −+ | ++ |

In another embodiment, the cymene is combined with an insect growth regulator.

Examples of the insect growth regulators which can be combined with cymene include methoprene, pyriproxyfen, lufenuron, azadirachtin, diofenolan, fenoxycarb, hydroprene, kinoprene, tetrahydroazadirachtin, buprofesin, and mixtures thereof, as well as diflubenzuron. In one embodiment, the insect growth regulator is methoprene and/or pyriproxyfen. In another embodiment, the insect growth regulator is methoprene and/or diflubenzuron.

The applicants have found that combinations of cymene and IGR show unexpectedly good insecticidal properties, including against mature insects, such as ticks and fleas, increasing mortality even over short time periods. This is unexpected in view of the different modes of action of the IGR. Long term, the combination is expected to give better effects.

The proportions of cymene to pyrethrin insecticide or insect growth regulator can vary over a wide range depending on such factors as the particular ingredients employed, the particular locus to be treated, the particular pests to be combated and the particular effect desired, for example whether a long residual period of control is required.

Overall, however, the proportions of cymene to pyrethrin insecticide or insect growth regulator may be for example (wt % for both components) from about 1:50 to about 40:1, usually from about 1:10 to about 10:1. Proportions from about 1:5 to about 5:1, for example from about 1:2.5 to about 2.5:1, a specific suitable proportion being about 1:1, may especially be employed, e.g. where a concentrate containing no additional material as synergist for the pyrethrin insecticide is diluted at the point of use against domestic insect pests and applied by spraying to give long residual control.

Parts, proportions and percentages in this specification are by weight unless otherwise indicated.

In a preferred embodiment the cymene is present in the composition in an amount of from about 2% w/w to about 10% w/w, preferably from about 2.5% w/w to about 5% w/w and most preferably about 5% w/w.

In a preferred embodiment the pyrethrin insecticide is present in the composition in an amount of from about 0.5% w/w to about 5% w/w, preferably from about 0.5% w/w to about 2% w/w, and most preferably from about 0.8% w/w.

In a preferred embodiment the insect growth regulator is present in the composition in an amount of from about 1 to about 10% w/w, preferably from about 3 to about 7% w/w.

The compositions may also comprise a surfactant.

Suitable surfactants according to the invention include one or more surfactants such as alkyl polyglucoside, calcium dodecylbenzene sulfonate, polyoxyethlenated alkyl phenols, sorbitan or sorbitan polyoxyethenlated esters or sodium petroleum sulphonate, Hyoxid X 45, Atlox 3400B, Emulsol MA, Tween 40, Tween 80, Span 40, Unitox 33× and IGSRF-6000 or other surfactants known in the art. These surfactants may be used alone or in combination. A preferred surfactant comprises a mixture of Tween 40 and Span 40 in a ratio of about 9:1 to about 1:9, preferably about 9:1 or Unitox 33× and IGSRF-6000 in a ratio of about 9:1 to about 1:9, preferably about 9:1. Preferably, the final composition is made to obtain about 10 to about 25% w/w of the active ingredient and about 5 to about 10% of calcium dodecylbenzene sulfonate, polyoxyethlenated esters or sodium petroleum sulfonate, Hyoxid X 45, Atlox 3400B, Emulsol MA, Tween 40, Tween 80, Span 40, Unitox 33× and IGSRF-6000 or other surfactants known in the art.

The surfactant is preferably present in the composition in an amount of from about 5 to about 30% w/w, most preferably in an amount of from 5 to 10% w/w.

Solutions of the composition may also contain one or more appropriate solvents which may suitably be selected from ethyl lactate, petroleum distillates, paraffinics and naphthenic solvents for example cyclohexanone, isoparaffin K, ethanol, isopropanol, xylene, or vegetable/mineral or synthetic oils such as polyalpha olefins. In some instances, natural organic emulsifiers may be preferred, particularly for organic farming applications. Coconut oil such as coconut diethanolamide and palm oil products such as lauryl stearate are examples of natural oil emulsifiers which can be used.

In a preferred embodiment the solvent is present in an amount of from about 30 to about 60% w/w, preferably in an amount of from about 40 to about 50% w/w.

The compositions may also be combined with a substance which increases the activity of pyrethrin insecticides known as a “potentiator”. An example of a suitable potentiator that has been commonly used to potentiate the activity of the pyrethrins against insect species is piperonyl butoxide (PBO). Dill oil such as dill seed oil or mixtures of two or more components thereof, is a further example of a potentiator which can be used in the compositions, and this is described and claimed for example in copending British patent application nos GB 0615475 and 0702915.

The ratio of potentiator to active ingredient, specifically the pyrethrin insecticide in the composition is preferably about 1:1 to about 1:10 and preferably in an amount of from about 1:2.5 to about 1:5.

The pesticidal compositions, and in particular the pesticidal compositions which comprise pyrethrins, can further comprise UV screening agents. Examples of suitable UV screening agents include titanium dioxide and carotene. Preferably, the carotene comprises one or more of αcarotene, β-carotene, γ-carotene, δ-carotene, ∈-carotene, lutein, lycopene and astaxanthin. Astaxanthin and β-carotene are preferred and may be used individually or in combination. Astaxanthin is most preferred and has been found to provide greater protection of UV-sensitive agrochemicals from UV-light. The composition of the present invention may comprise astaxanthin and/or β-carotene.

In a preferred embodiment the UV screening agent is present in the composition in an amount of from about 0.005% w/w to about 50% w/w, preferably from about 0.05% w/w to about 10% w/w, and most preferably from about 1% w/w to 5% w/w.

The ratio of cymene to UV screening agent (wt % for both components) in the composition is preferably 100:1 to 1:100, more preferably 25:1 to 1:5, most preferably, 1:1 to 1:5.

In a preferred embodiment the compositions of the present invention can be used to control flying and crawling insects.

The present invention provides a method for the control of pests which comprises administering to the pest or its environment a pesticidally effective amount of a pesticidal composition of the present invention.

The present invention also provides a method for the control and/or eradication of pest infestations of animals and/or of plants, (including trees), and/or stored products which comprises administering to the animal or locus an effective amount of a pesticidal composition of the present invention.

The present invention further provides for the pesticidal compositions of the present invention for use in human and veterinary medicine, in public health control and in agriculture for the control of pests.

The pesticidal compositions of the present invention are of particular value in the protection of field, forage, plantation, glasshouse, orchard and vineyard crops, of ornamentals and of plantation and forest trees, for example, cereals (such as maize, wheat, rise, sorghum), cotton, tobacco, vegetables and salads (such as beans, cole crops, lettuce, onions, tomatoes and peppers), field crops (such as potato, sugar beet, ground nuts, soybean, oil seed rape), sugar cane, grassland and forage (such as maize), plantations (such as tea, coffee, cocoa, banana, oil palm, coconut, rubber, spices), orchards and groves (such as of stone and pip fruit; citrus, kiwifruit, mango, avocado, olives and walnuts, vineyards, ornamental plants, flowers and shrubs under glass and in gardens and parks, forest trees (both deciduous and evergreen) in forests, plantations and nurseries.

They are also valuable in the protection of timber (standing, felled, converted, stirred or structural) from attack by saw flies or beetles.

They have applications in the protection of stored products such as grains, fruits, nuts, spices and tobacco, whether whole, milled or compounded into products from moth, beetle and mite attack. Also protected are stored animal products such as skins, hair, wool and feathers in natural or converted form (such as carpets or textiles) from moth and beetle attack; also stored meat and fish from beetle, mite and fly attack.

The pesticidal compositions of the present invention are, therefore, useful in the control of arthropods e.g. insects and acarines in any environment where these constitute pests such as in agriculture, in animal husbandry, in public health control and in domestic situations.

Insect pests include whitefly, thrips, termites (Isoptera), cockroaches, flies, aphids (Homoptera), beetles (Coleoptera), bugs, water bugs (Heteroptera), sawflies, wasps, bees and ants (Hymenoptera), mites, midges, moths and butterflies (Lepidoptera), leafhoppers and mosquitoes.

In particular the compositions of the invention are 15 envisaged for the control of the following species of whitefly:

Trialeurodes vaporariorum (Glasshouse Whitefly), Trialeurodes abutilonea, Aleurothirus floccosus, Aleurodicus disperses, Bemisia argentifolia (Silverleaf Whitefly), Bemisia tabaci, Bemisia graminus, Pseudaulacaspis pentagona (White Peach Scale), and in particular Bemisia tabaci, Bemisia argentifolia, Trialeurodes vaporariorum and Pseudaulacaspis pentagona.

In particular the compositions of the invention are envisaged for the control of the following species of thrips:

Frankliniella occidentalis, Thrips tabaci, Thrips palmi, Scirtothrips aurantii, Scirtothrips citri, Limnothrips cerealium, Haplothrips tritici, Kanothrips robustus, Diarthrothrips coffeae, Taenothrips inconsequeus, Taenothrips simplex, Heterothrips azaleae, Liothrips oleae and Heliothrips haemorhoidalis and in particular Frankliniella occidentalis, Thrips tabaci and Thrips palmi

In particular the compositions of the invention are envisaged for the control of the following species of termites (Isoptera): Arid-land subterranean termite, common dry-wood termite, damp-wood termite, dry-wood termite, eastern subterranean termite, Formosan subterranean termite, pacific damp-wood termite, south-eastern dry-wood termite, southern dry-wood termite, subterranean termite, tree termite, western dry wood termite and western subterranean termite.

In particular the compositions of the invention are envisaged for the control of the following species of cockroaches:

Madagascar cockroach, American cockroach, brown-banded cockroach, German cockroach, oriental cockroach, smoky-brown cockroach, woods cockroach, Australian cockroach, brown cockroach, Surinam cockroach and Florida woods cockroach.

In particular the compositions of the invention are envisaged for the control of the following species of fly: House fly, sand fly, stable fly, tsetse fly, black fly,

In particular the compositions of the invention are envisaged for the control of the following species of aphid (Homoptera): Aphis fabae (Black Bean Aphid), Acyrthosiphum pisum (Pea Aphid), Brevicoryne brassicae (Cabbage Aphid), Sitobion avenae (Grain Aphid), Cavariella aegopodii (Carrot Aphid), Aphis craccivora (Groundnut Aphid), Aphis gossypii (Cotton Aphid), Aphis nasturii, Aphis idaei, Aphis citricol, Toxoptera aurantii (Black Citrus Aphid), Drepanoiphum platanoides, Myzus persicae, Myzus ascalonicas, Myzus ornatus, Rhopalosiphum padi, and Metapolophium dirhodum. Particular examples are Myzus persicae and Aphis fabae.

In particular the compositions of the invention are envisaged for the control of the following species of beetle (Coleoptera): Mealworm beetle, Monochamus alternatus (Japanese pine sawyer), Rosemary leaf beetle, Asparagus beetle and Red Lily beetle.

In particular the compositions of the invention are envisaged for the control of the following species of bug: Bed bug, redjuvid bug, cone nose bug,

In particular the compositions of the invention are envisaged for the control of the following species of water 20 bugs (Heteroptera): Dysdercus fasciatus (cotton stainer)

In particular the compositions of the invention are envisaged for the control of the following species of ants (Hymenoptera):

Argentine ant, Big-headed ant, black imported fire ant, brown carpenter ant, cornfield ant, Florida carpenter ant, Imported fire ant, large yellow ant, leaf cutter ant, little black ant, odorous house ant, pavement ant, pharaoh ant, red carpenter ant, red imported fire ant, small yellow ant, southern fire ant, Texas leaf cutting ant and thief ant.

In particular the compositions of the invention are envisaged for the control of the following species of mite: Panonychus species such as Panonychus ulmi (Red Spider Mite), Panonychus citri (Citrus Red Mite), Tetranychus species such as Tetranychus urticae (Two spotted Spider Mite), Tetranychus cinnabarinus (Carmine Spider Mite), Tetranychus kanzawi (Kanzawa Spider Mite), Tetranychus pacificus (Pacific Spider Mite), Tetranychus turkestani (Strawberry Mite), Oligonychus species such as Oligonychus panacea (Avocado Brown Mite), Oligonychus persea (Persea Mite), Oligonychus pratensis (Banks Grass Mite), and Oligonychus coffeae, Aculus species such as Aculus cornatus (Peach Silver Mite), Aculus fockeni (Plum Rust Mite) and Aculus lycopersici (Tomato Russet Mite), Eotetranychus species such as Eotetranychus wilametti, Eotetranychus yumensis (Yuma Spider Mite) and Eotetranychus sexmaculatis (Six Spotted Mite), Bryobia rubrioculus (Brown Mite), Epitrimerua pyri (Pear Rust Mite), Phytoptus pyri (Pear Leaf Blister Mite), Acalitis essigi (Red Berry Mite), Polyphagotarsonemus latus (Broad Mite), Eriophyes sheldoni (Citrus Bud Mite), Brevipalpus lewisi (Citrus Flat Mite), Phylocoptruta oleivora (Citrus Rust Mite), Petrobia lateens (Brown Wheat Mite), Oxyenus maxwelli (Olive Mite) and Diptacis gigantorhyncus (Bigheaded Plum Mite). Particular examples are Tetranychus urticae, Tetranychus cinnabarinus, Tetranychus kanzawi, Panonychus ulmi, Panonychus citri and Phylocoptruta oleivora.

In particular the compositions of the invention are envisaged for the control of the following species of moths and butterflies (Lepidoptera):

Lobesia botrana (European grapevine moth), Pieris melete (White butterfly) and Pieris napi (Green-veined white butterfly).

In particular the compositions of the invention are envisaged for the control of the following three major genra of medically important mosquitoes which transmit diseases, namely Anopheles, Culex and Aedes, for example anopheles gambiae, culex quinquefasciatus, and aedes aegypti.

In a preferred embodiment the compositions of the invention are used for the control of whiteflies, thrips, mosquitoes and aphids.

The pesticidal compositions of the present invention may be employed alone or in the form of mixtures with such solid and/or liquid dispersible carrier vehicles if desired, or in the form of particular dosage preparations for specific application made there from, such as solutions, emulsions, suspensions, powders, pastes, and granules which are thus ready for use. The pesticidal compositions can be formulated or mixed with, if desired, conventional inert diluents or extenders of the type usable in conventional pesticide formulations or compositions, e.g. conventional pesticide dispersible carrier vehicles such as gases, solutions, emulsions, suspensions, emulsifiable concentrates, spray powders, RTU micro-emulsions, oil-in-water emulsions, pastes, soluble powders, dusting agents, granules, foams, pastes, tablets, aerosols, ready to use trigger sprays, natural and synthetic materials impregnated with active compounds, microcapsules, coating compositions, and formulations used with burning equipment, such as fumigating cartridges, fumigating cans and fumigating coils, as well as ULV cold mist and warm mist formulations.

The formulations are preferred to be water soluble or 5 miscible since they are diluted in water before use to achieve an appropriate concentration.

Liquid treatments can be applied by spraying. Formulations include water-soluble powders (SP), soluble (liquid) concentrates, wettable powders (WP) or water-dispersable granules (WG). Solid formulations such as granules or briquettes, where the active ingredient is mixed with bulking agents such as sawdust, sand or plaster, can easily be used by introduction of the formulation into water containers such as tanks or latrines. For the treatment of water, it is of particular benefit to formulate the composition so that the active ingredients will be released slowly over a period of time. This avoids the need for continuous re-treatment.

The compositions are preferably formulated as an emulsifiable concentrate. Generally, a 25-50% solution of the pesticide in a solvent is used and at least 10% solubility is typically needed to make the formulation economic to transport. In many cases, pesticides are soluble in organic solvents but not in water. In addition to appropriate solvents, emulsifiers are added to ensure that a fine oil drop (1-2 nm) in water emulsion is produced when the formulation is diluted with water. The resultant emulsion appears opaque and does not settle for 24 hours. ECs are a convenient way of formulating water-insoluble ingredients and they do not cause nozzle abrasion. Typical solvents for conventional emulsifiable concentrates are non-polar water-immiscible solvents or polar aprotic water miscible organic solvents. These solvents have very low solubilities in water and are capable of dissolving a wide range of active ingredients.

The non-polar solvents are selected from the group consisting of aliphatic or aromatic hydrocarbons and esters of plant oils or mixtures thereof.

Aliphatic and aromatic hydrocarbons such as hexane, cyclohexane, benzene, toluene, xylene, mineral oil or kerosin or substituted naphthalenes, mixtures of mono- and polyalkylated aromatics are, for example, commercially available under the registered trademarks Solvesso, Shellsol, Petrol Spezial and Exxsol.

Esters of plant oils, which are used as nonpolar, water-immiscible solvents according to the present invention are alkyl esters obtainable from medium chained fatty acids by esterification with alkanols or by transesterification of the corresponding plant oils preferably in the presence of a lipase. Preferred fatty acids of these plant oils have about 5 to about 20, in particular about 6 to about 15 carbon atoms. In a preferred embodiment, the methyl ester of the plant oil used is the methyl ester of caprylic/capric ester or of capric ester having a distribution of fatty acid chain lengths around 10 units. Particularly preferred methyl esters of plant oils are Witconol 1095 and Witconol 2309 which are commercially available from the Witco Corporation, Houston, USA.

The water-miscible polar aprotic organic solvents are preferably compounds which exhibit a dielectric constant of about 2.5 or more at 25° C., in particular from about 2.7 to about 4.0 at 25° C. Particularly preferred are cyclic amides and lactones, for example N-methylpyrrolidone, N-cyclohexylpyrrolidone and γ-butyrolactone and N-methylpyrrolidone or mixtures thereof.

Also preferred are water-miscible polar aprotic solvents selected from the group consisting of alkyl lactates, in particular, isopropyl lactate such as plurasolv IPL which is obtainable from Plurac, alkyl carbonates, polyethylene glycols, polyethylene glycol alkyl ethers, polypropylene glycol alkyl ethers, and most preferably particular isopropyl lactate, or mixtures thereof.

The emulsifiers may comprise at least one emulsifier which can be a non-ionic surfactant, ionic surfactant or a blend 20 of both type of surfactants.

Examples of the nonionic surfactants which can be used include: alkoxylate block polymers, alkoxylated alcohols, alkoxylated alkylphenols; alkoxylated amines, alkoxylated amides; alkoxylated fatty esters, alkoxylated oils, fatty esters, alkoxylated fatty acids and sorbitan derivatives. In a preferred embodiment the nonionic surfactants can include alkoxylated alcohols, ethoxylated glycerides and ethoxylated tristyryl. The nonionic emulsifier can be present in the emulsifiable concentrate in an amount of from about 1 to about 15% w/w. Examples of the ionic surfactants which can be used include: alkylaryl sulfonates; alkylaryl sulfonic acids; carboxylated alcoholethoxylates and alkylphenol ethoxylates; carboxylic acids/fatty acids; diphenyl sulfonate derivatives; olefin sulphonates; phosphate esters; phosphorous organic derivatives; quaternary surfactants; sulfates and sulfonates of oils and fatty acids; sulfates and sulfonates ethoxylated alkylphenols; sulfates of ethoxylated alcohols; sulfates of fatty esters; sulfonates of dodecyl and tridecylbenzenes; sulfonates of naphthalene and alkyl naphthalene; sulfonates of petroleum; sulfosuccinamates, alkanolamides and alkoxylated amine. In a preferred embodiment the ionic surfactant can be salts of dodecylbenzene sulfonic acid. The ionic emulsifier can be present in the emulsifiable concentrate in an amount of from about 0.5 to about 10% w/w.

An emulsifiable concentrate can also include an anti-freeze agent. Examples of suitable anti-freeze agents include relatively low molecular weight aliphatic alcohols such as ethylene glycol, propylene glycol, diethylene glycol, glycerine, urea, hexane diol, and sorbitol. Preferred anti-freeze agents include dipropylene glycol, diethylene glycol, glycerine, urea, hexylene glycol and propylene glycol. The anti-freeze agent can be present in the emulsifiable concentrate in an amount of from about 1 to about 10% w/w.

The pesticidal compositions can also be used as ready-to-use (RTU) micro-emulsions. The RTU micro-emulsions can comprise at least one emulsifier, the examples of which are the same as used in emulsifiable concentrates as outlined above. The nonionic emulsifier can be present in the micro-emulsion in an amount of from about 0.002 to 0.1% w/w. The ionic emulsifier can be present in the micro-emulsion in an amount of from about 0.002 to 0.1% w/w.

The RTU-micro-emulsions can also include an anti-freeze agent, the examples of which are the same as used in emulsifiable concentrates as outlined above. The anti-freeze agent can be present in the micro-emulsion in an amount of from about 1 to about 10% w/w.

In a preferred embodiment the pesticidal compositions are used as aerosol-based applications, including aerosolized foam applications. Pressurised cans are the typical vehicle for the formation of aerosols. An aerosol propellant that is compatible with the pesticide composition is used. Preferably, a liquefied-gas type propellant is used. Suitable propellants include compressed air, carbon dioxide, butane and nitrogen. The concentration of the propellant in the pesticide composition is from about 5% to about 75% by weight of the pesticide composition, preferably from about 15% to about 50% by weight of the pesticide composition.

The pesticide formulation can also include one or more foaming agents. Foaming agents that can be used include sodium laureth sulphate, cocamide DEA, and cocamidopropyl betaine. Preferably, the sodium laureth sulphate, cocamide DEA and cocamidopropyl are used in combination. The concentration of the foaming agent(s) in the pesticide composition is in the ratio of foaming agent:active ingredient of from about 0.5:4 to about 2:1, and preferably from about 0.75:1 to about 1.5:1.

When the pesticide formulation is used in an aerosol application not containing foaming agent(s), the composition of the present invention can be used without the need for mixing directly prior to use. However, aerosol formulations containing the foaming agents do require mixing (i.e. shaking) immediately prior to use. In addition, if the formulations containing foaming agents are used for an extended time, they may require additional mixing at periodic intervals during use.

An area may also be treated with the pesticidal composition by using a burning formulation, such as a candle, a smoke coil or a piece of incense containing the composition. For example, composition may be comprised in household products such as “heated” air fresheners in which pesticidal compositions are released upon heating, for example, electrically, or by burning.

The pesticidal compositions are also particularly suited for administration as a spot-on formulation on companion animals. Spot-on formulations are well know techniques for topically delivering an active agent to a limited area of the host. Spot-on formulations may be prepared by dissolving the active ingredients into a pharmaceutically or veterinary acceptable vehicle. Alternatively, the spot-on formulation can be prepared by encapsulation of the active ingredient to leave a residue of the therapeutic agent on the surface of an animal. These formulations will vary with regard to the weight of the therapeutic agent in the combination depending on the species of host animal to be treated, the severity and type of infection and the body weight of the host.

The pesticidal compositions are also particularly suited for administration as a shampoo on companion animals.

In a preferred embodiment the pesticidal composition composition comprising cymene, preferably p-cymene and a pyrethrin insecticide are administered as an aerosol formulation. Such an aerosol formulation is particularly suited for use with mosquitoes as good knock down as well as mortality is achieved.

In a preferred embodiment the pesticidal composition comprising cymene and an insect growth regulator is preferably administered as a spot-on formulation, an aerosol formulation, a shampoo or a ready to use trigger spray.

The invention will now be described with respect to the following examples. The examples are not intended to be limiting of the scope of the present invention but read in conjunction with the detailed and general description above, provide further understanding of the present invention and an outline of a preferred process for preparing the compositions of the invention

### EXAMPLE 1

### Use of Combination of P-Cymene and Pyrethrum

### Insect Species Used

All species used in this study are from colonies held in permanent culture at London School of Hygiene and Tropical Medicine (LSHTM) see http://www.Lshtm.ac.uk/dcvbu/insect/index.htm). All insects are reared and tested under optimal environmental conditions of 24° C.±2° C., and 75-80% RH with a 12:12 hour day/night.

### Species Used:

Anopheles gambiae
Musca domestica (House Fly)

### Periplaneta Americana (American Cockroach)

### Samples Used:

5.0% w/w p-cymene

### 27.4% w/w Isoparaffin K

1.0% w/w piperonyl butoxide

### 0.8% w/w Pyrethrum (50%)

### 25.7% w/w Isopropanol

### 40.0% w/w L.P.G. 40

### Method

The samples to be tested were placed in a metal aerosol can.

All tests were conducted in a free-flying sealed test chamber. The test chamber was 15 m³ and all internal surfaces (floor, walls and ceiling) were lined with white ceramic tiles to enhance detection of insects and facilitate rapid and thorough decontamination. An external vent-axia fan permitted forced ventilation of room air between tests. All surfaces were cleaned with 10% Decon and/or 70% ethanol between tests.

Batches of 30 adult flying insects (Anopheles gambiae mosquitoes and Musca domestica houseflies) were released into the test room which was maintained at optimal environmental conditions of 24° C.±2° C., and 75-80% RH. Crawling insects (Periplaneta Americana cockroaches) were tested in the same manner but were enclosed with a Perspex box with climb-resistance walls. The test sample was sprayed for a duration of 3 seconds held at head height in a rotating manner into the room by the test supervisor to give an even release of spray throughout the chamber.

Insects were recorded as they were knocked down onto the floor for a period of 15 minutes. After 15 minutes, any insects not knocked down were collected and placed into paper holding cups and supplied with 10% glucose and held overnight at optimal environmental conditions of 24° C.±2° C., and 75-80% RH. Mortality was recorded 24 hours post exposure. A minimum of 6 replicates were conducted on each insect species. Control replicates using 5% ethanol spray were used in each case to ensure negative control mortality was below 10%.

The method of application was similar to that used by commercial insecticide fly spray products in current domestic use.

To investigate the possible residual activity of the crawling insect formulation a further series of bioassays were conducted a further 24 hours post application of the sample by releasing batches of P. Americana in a similar manner to the previously treated holding box in the test chamber.

TABLE 1

| | 15 min Knock | 24 hour |
|---|---|---|
| INSECT SPECIES | Down (KD) | mortality |
| Musca domestica (House Fly) | 84% | 100% |
| Periplaneta Americana | 74% | 98% |
| (American Cockroach) | | |
| Anopheles gambiae | 100% | 100% |

Residual Activity (24 Hours post use)
P. Americana 66% knock down and 78% mortality

The tested samples show a substantially rapid knockdown activity and high mortality. The tested samples have, therefore, considerable use in domestic aerosol pesticide applications.

### EXAMPLE 2

### Use of Combination of P-Cymene and IGR

The IGR's Methoprene and Diflubenzuron were sources as WHO standard preparations at 20 mg/l technical from WHO, Geneva, and used as positive controls or mixtures (50:50) with 5.0% p-cymene.

Laboratory colonies of the cat flea (Ctenocephalides felis) and the Deer Tick (Ixodes ricinus) were used in bioassays undertaken at room temperature.

Bioassays consisted of plastic pots with a netting cover holding batches of 10 adult insects of each species being placed under a potter tower which then sprayed a fine particulate aerosol of even rate. Application rates were always 1.0 ml/pot which is sufficient to wet the inner surface without leaving free liquid residues. After exposure to the treatment or a 5% ethanol control, arthropods were then transferred to a clean plastic holding pot and held at room temperature for 3 days with mortality scored after 24 & 72 hours. Mortality was calculated as % of negative control.

### Results

| | | 24 hours | 72 hours |
|---|---|---|---|
| Test Sample | Species | mortality | mortality |
| p-cymene | C. felix | 76% | 88% |
| p-cymene | I. ricinus | 28% | 55% |
| p-cymene + | C. felix | 80% | 92% |
| Methoprene | | | |
| p-cymene + | I. ricinus | 30% | 64% |
| Methoprene | | | |
| p-cymene + | C. felix | 84% | 90% |
| Diflubenzuron | | | |
| p-cymene + | I. ricinus | 33% | 68% |
| Diflubenzuron | | | |

The results show that mixtures of p-cymene with IGR produced a better kill in both mature species in the short term (up to 3 days). This is surprising in view of the fact that activity of IGR is generally not demonstrated in this fashion.

1. A pesticidal composition which comprises cymene and either a pyrethrin insecticide or an insect growth regulator.

2. The pesticidal composition of claim 1 which comprises a pyrethrin insecticide.

3. The pesticidal composition of claim 2 wherein the pyrethrin insecticide comprises pyrethrin.

4. The pesticidal composition of claim 2 wherein the pyrethrin insecticide is a synthetic pyrethroid with “knock-down” activity.

5. The pesticidal composition of claim 4 wherein the pyrethroid insecticide is selected from allethrin, bioallethrin, S-bioallethrin, bioresmethrin, kadethrin, resmethrin, tetrainethrin, cypermethrin, deltamethrin, fenvalerate and permethrin.

6. The pesticidal composition of claim 1 which comprises cymene and an insect growth regulator.

7. The composition of claim 6 wherein the insect growth regulator is selected from the group consisting of methoprene, pyriproxyfen, lufenuron, azadirachtin, diofenolan, fenoxycarb, hydroprene, kinoprene, tetrahydroazadirachtin, diflubenzuron and mixtures thereof.

8. The composition of claim 7 wherein the insect growth regulator is methoprene, diflubenzuron or mixtures thereof.

9. The composition of claim 1 wherein the composition comprises a synthetically prepared cymene.

10. The composition of claim 1 wherein the cymene is p-cymene.

11. The composition of claim 1 further comprising a potentiator selected from the group consisting of piperonyl butoxide of dill oil or two or more active components thereof.

12. The composition of claim 1 which is in the form of an aerosol.

13. A method for the control of pests which comprises administering to the pest or its environment a pesticidally effective amount of the pesticidal composition as defined in claim 1.

14. A method for the control and/or eradication of pest infestations of animals and/or of plants, and/or stored products which comprises administering to the animal or locus an effective amount of the pesticidal composition as defined in claim 1.

15. (canceled)

16. A process for preparing the pesticidal composition as defined in claim 1 which comprises combining cymene with a pyrethrin insecticide or an insect growth regulator.

17. (canceled)
